(19) United States
(12) Patent Application Publication
(10) Pub. No.: US 2025/0272466 A1
(43) Pub. Date: Aug. 28, 2025

(54) POWER PERFORMANCE AREA OPTIMIZATION IN DESIGN TECHNOLOGY CO-OPTIMIZATION FLOWS

(71) Applicant: Synopsys, Inc., Sunnyvale, CA (US)

(72) Inventors: Wenwen CHAI, San Jose, CA (US); Li DING, San Jose, CA (US)

(21) Appl. No.: 18/590,646

(22) Filed: Feb. 28, 2024

(51) Int. Cl. G06F 30/392

(52) U.S. Cl. CPC G06F 30/392

(57) ABSTRACT

Systems and methods for maximizing power, performance, and area (PPA) gains for integrated circuits are presented. A method includes constructing a surrogate model representing an impact of a plurality of metrics to a plurality of process parameters, performing a sweep to determine a number of samples in an optimization space, selecting a subset of sample candidates from the surrogate model, and generating a PPA model based on the subset of sample candidates to output improved sample sets. Another method includes creating multiple parameter groups in an optimization space, each group including samples of a different process parameter, selecting dominant samples in each group, and performing co-optimization using the dominant samples from each group. Yet another method includes generating the PPA model, assessing PPA impact for each process point, updating a PPA frontal sample set, and performing analysis on the PPA frontal sample set to generate a PPA Pareto front.

### TECHNICAL FIELD

The present disclosure generally relates to power, performance, and area (PPA) optimization of integrated circuits. More specifically, the present disclosure relates to PPA optimization in design technology co-optimization (DTCO) flows.

### BACKGROUND

Power, performance, and area (PPA) optimization is a holistic approach in semiconductor design aimed at achieving the best balance between power consumption, performance, and chip area. PPA provides an important consideration in the development of integrated circuits (ICs) to ensure that the final product meets the desired specifications and requirements.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example design technology co-optimization (DTCO) flow to achieve power, performance, and area (PPA) optimization.

FIG. 2A illustrates an example first method for achieving fast and high-quality design-scale process optimization using a domain-specific search algorithm.

FIG. 2B illustrates PPA points or samples on a plot when using the domain-specific search algorithm.

FIG. 3 illustrates an example second method for achieving fast and high-quality design-scale process optimization by performing co-optimization of multiple groups.

FIG. 4A illustrates an example flowchart of a third method for achieving fast and high-quality design-scale process optimization using a PPA Pareto front.

FIG. 4B illustrates the PPA points or samples on a plot when using the PPA Pareto front.

FIG. 4C illustrates an example collection of best samples in all bins according to a first embodiment.

FIG. 4D illustrates an example collection of best samples in all bins according to a second embodiment.

FIG. 5 illustrates an example plot where designers can select PPA points based on design requirements.

FIG. 6 illustrates an example computer system in which embodiments of the present disclosure may operate.

FIG. 7 illustrates an example set of processes used during the design, verification, and fabrication of an article of manufacture such as an integrated circuit to transform and verify design data and instructions that represent the integrated circuit.

### DETAILED DESCRIPTION

Aspects of the present disclosure relate to power, performance, and area (PPA) optimization in design technology co-optimization (DTCO) flows. Further aspects of the present disclosure relate to maximizing PPA gains.

PPA optimization is a holistic approach in semiconductor design aimed at achieving the best balance between power consumption, performance, and chip area. PPA optimization is an important consideration in the development of integrated circuits to ensure that the final product meets the desired specifications and requirements.

Power relates to power consumption, which is a key concern in electronic devices. Lower power consumption translates to longer battery life, reduced heat dissipation, and enhanced environmental sustainability. PPA analysis assesses power usage at various stages of chip operation, from idle states to peak performance, to ensure efficient power management.

Performance is often measured in terms of clock frequency or execution speed, and determines how quickly a chip can process instructions and deliver results. A higher-performing chip enables faster computation and improved user experience. PPA analysis aims to achieve the highest performance possible while adhering to power and area constraints.

Area refers to an area of a chip, which is the physical space it occupies on the silicon (Si) die. Smaller chips allow for higher densities, leading to cost savings and increased functionality. PPA analysis strives to minimize the chip's physical footprint while maintaining desired power and performance characteristics.

As such, PPA can refer to metrics that are used in the semiconductor industry for comparing, e.g., processor cores or other electronic components.

By optimizing power, performance, and area simultaneously, semiconductor designers aim to find a balanced solution that meets the specific requirements of the application. Achieving an optimal PPA balance is essential for designing efficient and competitive integrated circuits (ICs) across various industries, including consumer electronics, automotive, and industrial applications.

With the slowdown of Moore's Law, DTCO has become important for continuing the rapid scaling of Si transistors. DTCO involves jointly considering manufacturing processes and system performance to guide developments in advanced technology nodes and evaluate emerging materials/devices. Unlike traditional technology development, where process optimization and system performance evaluations are separate stages, DTCO integrates system performance and reliability considerations early in the process and device optimization.

DTCO is a concept in the semiconductor industry that involves optimizing both the design and manufacturing technologies simultaneously. In the context of semiconductor manufacturing, DTCO refers to the collaborative optimization of the chip design and the manufacturing process technology to achieve better performance, power efficiency, and cost-effectiveness.

Traditionally, chip design and manufacturing were treated as separate phases in the semiconductor development process. However, as technology has advanced, close collaboration between design and manufacturing teams can lead to better overall outcomes. DTCO aims to address the challenges and constraints associated with the complex interplay between design considerations and the capabilities of the manufacturing process.

By co-optimizing design and technology, semiconductor manufacturers can achieve improvements in various aspects, such as performance, power consumption, and yield. This approach becomes particularly important as semiconductor technology advances and reaches smaller process nodes, where the interactions between design and manufacturing become more intricate. Overall, DTCO is a holistic approach that involves considering both design and manufacturing aspects concurrently to achieve optimal results in semiconductor chip development.

Conventional design PPA optimization includes two orthogonal approaches, that is, process optimization and design optimization. Process optimization is performed by foundries, such as technology computer-aided design (TCAD) users at an early stage of a process design kit (PDK) definition. There are many choices among a variety of technology variants such as materials, device definitions, layer definitions, physical rules, and electrical rules. For fast turnaround, process optimization is usually performed on a small collection of cells. Regarding design optimization, such optimization is performed by design teams on actual production design after the process is defined. Design optimization uses a large design cycle time with multiple steps such as library characterization, placement and routing, signoff analysis, and multiple iterations of engineering change orders (ECOs) to meet PPA targets.

In previous technology nodes, independent process and design development may already be adequate to meet PPA requirements. However, for more advanced technology nodes, process definition and design techniques become more complicated, thus resulting in challenging optimization issues. A closer interaction between process and design becomes more important in order to maximize PPA.

Attempts have been made to perform both process and design optimization at the design level. However, runtime-wise, a design-process co-optimization feedback loop is too expensive. Such design-process co-optimization feedback loop formulates a high-dimensional optimization problem resulting in millions to billions of design-level runs. Each design-level run involves expensive library characterization and parasitics extraction. A production library can take weeks to months to be characterized because a cell library comprises timing, power, and layout information for various standard cells based on given timing arcs, output loads, and input transitions. The cell library can vary significantly for different process-voltage-temperature (PVT) corners. Thus, during system-level DTCO iterations, especially for the process development of emerging materials, it becomes necessary to characterize the cell library over a wide range of voltages, temperatures, and threshold voltages whenever materials or device structures are updated. Additionally, when evaluating the aging-induced reliability of a new process/device, such as hot carriers injections (HCl) and negative bias temperature instability (NBTI), the cell library needs to be characterized across a wide range of aging-induced threshold voltage shifts. This approach becomes increasingly expensive and time-consuming as the number of analyses grows dramatically for advanced technology nodes and emerging technologies. The prohibitively high runtime limits the success of design-process co-optimization.

A common compromise is to use a small integrated circuit block with a limited number of library cells for PPA assessment. However, the optimization quality cannot be guaranteed on actual production designs.

To address such issues, three exemplary methods are presented.

The first method for achieving fast and high-quality design-scale process optimization for different types of DTCO flows involves using a domain-driven search algorithm.

The second method for achieving fast and high-quality design-scale process optimization for different types of DTCO flows involves performing fast co-optimization of multiple parameter groups. In one practical application, the multiple parameter groups include combining front-end-of-line (FEOL) and back-end-of-line (BEOL) process parameters.

The third method for achieving fast and high-quality design-scale process optimization for different types of DTCO flows involves performing fast generation of the PPA Pareto front.

The three methods enable fast DTCO and can be applied to different types of DTCO flows such as early DTCO, late DTCO, and static timing analysis (STA) driven or implementation tool driven DTCO for process selection to maximize PPA gains

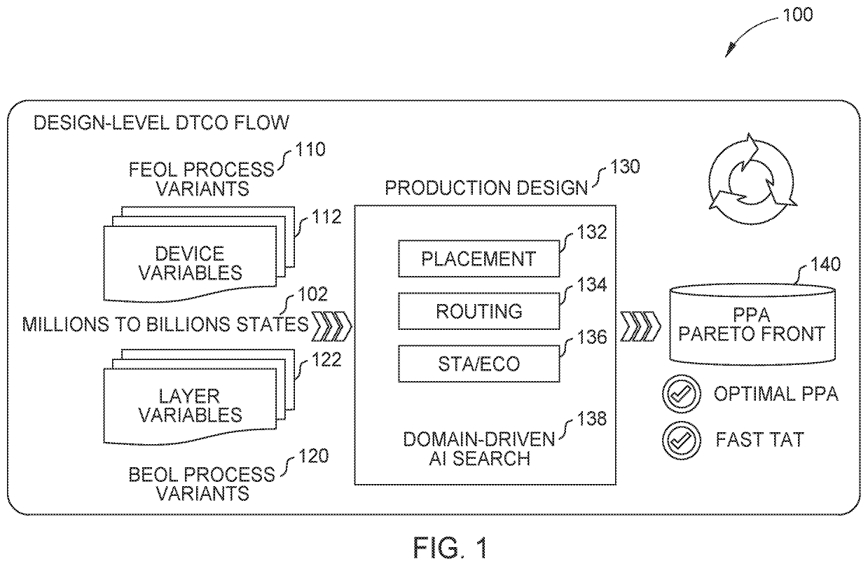

FIG. 1 illustrates an example DTCO flow to achieve PPA optimization.

As semiconductor components continue to shrink, the challenges associated with design-for-manufacturing (DFM) and DTCO increase. The complexity of the IC design and manufacturing process demands an extension of traditional DFM and DTCO techniques to overcome the systematic failures tied to complex design-process interactions.

The IC design-to-manufacturing flow has well-defined modules such as physical design, mask synthesis, mask writing, fab process and inspection and test. Each module includes industry-standard verification processes, such as physical verification, optical process correction and mask proximity correction (OPC/MPC) verification, metrology inspection and physical failure analysis (PFA).

DTCO is important for yield breakthrough and product ramp-up during the life cycle of a new technology node. DTCO involves the simultaneous optimization of the chip design and manufacturing process, considering the interdependence between the two. DTCO uses iterative design and manufacturing simulations to identify optimal design and manufacturing parameters.

Later in the process node's lifecycle, such co-optimization is done by traditional techniques like DFM and litho-friendly design (LFD). However, with the shrinking manufacturing technology and growing design complexity comes greater challenges that existing DFM and DTCO can't overcome.

Traditional DTCO, DFM, and LFD approaches all have proven value, but many designs need more. Systematic defects escape traditional detection methodology and show up during the yield ramp and final high-volume manufacturing (HVM). To improve the efficiency and effectiveness of the DFM and DTCO processes for complex, advanced node designs, the industry needs more methodologies that perform fast and high-quality PPA searches to maximize PPA gains. The exemplary embodiments present such methodologies that maximize PPA gains.

Referring back to FIG. 1, the DTCO flow 100 includes millions to billions of states 102 provided to a production design phase 130. In one example, the states 102 can include FEOL process variants 110 and BEOL process variants 120. The FEOL process variants 110 may relate to device variables 112, whereas the BEOL process variants 120 may relate to layer variables 122.

In the production design phase 130, placement 132, routing 134, and STA/ECO processes 136 processes are performed during the domain-driven artificial intelligence (AI) search 138. After the domain-driven AI search 138 is complete, the PPA search results are generated and represented as PPA Pareto front 140. The PPA Pareto front 140 allows for a designer to select an optimal PPA point. Optimal solution sets can be generated for best Fₘₐₓ, best power, and/or a tradeoff between Fₘₐₓ and power.

The placement 132 is the portion of the physical design flow that assigns exact locations for various circuit components within a chip's core area. A placer performs the assignment while optimizing a number of objectives to ensure that a circuit meets its performance demands. A placer takes a given synthesized circuit netlist together with a technology library and produces a valid placement layout. The layout is optimized according to the objectives and is ready for cell resizing and buffering.

The routing 134 builds on placement, which determines the location of each active element of an IC or component on a printed circuit board (PCB). After placement, the routing step adds wires needed to properly connect the placed components while obeying all design rules for the IC. The routing 134 involves providing some pre-existing polygons consisting of pins (or terminals) on cells, and optionally some pre-existing wiring called preroutes. Each of these polygons are associated with a net, usually by name or number. The primary task of the router is to create geometries such that all terminals assigned to the same net are connected, no terminals assigned to different nets are connected, and all design rules are obeyed.

Regarding STA/ECO processes 136, STA is a method of validating the timing performance of a design by checking all possible paths for timing violations. STA breaks a design down into timing paths, calculates the signal propagation delay along each path, and checks for violations of timing constraints inside the design and at the input/output interface.

Regarding STA/ECO processes 136, in the context of a system-on-chip (SoC) flow, a functional ECO is a method to directly patch, or modify the gate-level, post synthesis version of a design. The reason for this modification could include fixing an error that was discovered in the register transfer level (RTL) (pre-synthesis) version of the design, applying optimization to the design or updating the design based on a new customer requirement. ECOs provide an important late-stage optimization step for any design. This is where errors are corrected, optimization is applied, and late-stage customer requests are accommodated.

The PPA Pareto front 140 provides for the best PPA solution set that can cover the entire frequency range or power range. The PPA Pareto front 140 is a set of processor solutions that provide for either the best power or the best frequency. For example, given a frequency value, it can be determined what the best power that can be achieved is. Alternatively, given a power value, it can be determined what the best frequency that can be achieved is. The PPA solution set provides for a tradeoff between, e.g., frequency and power.

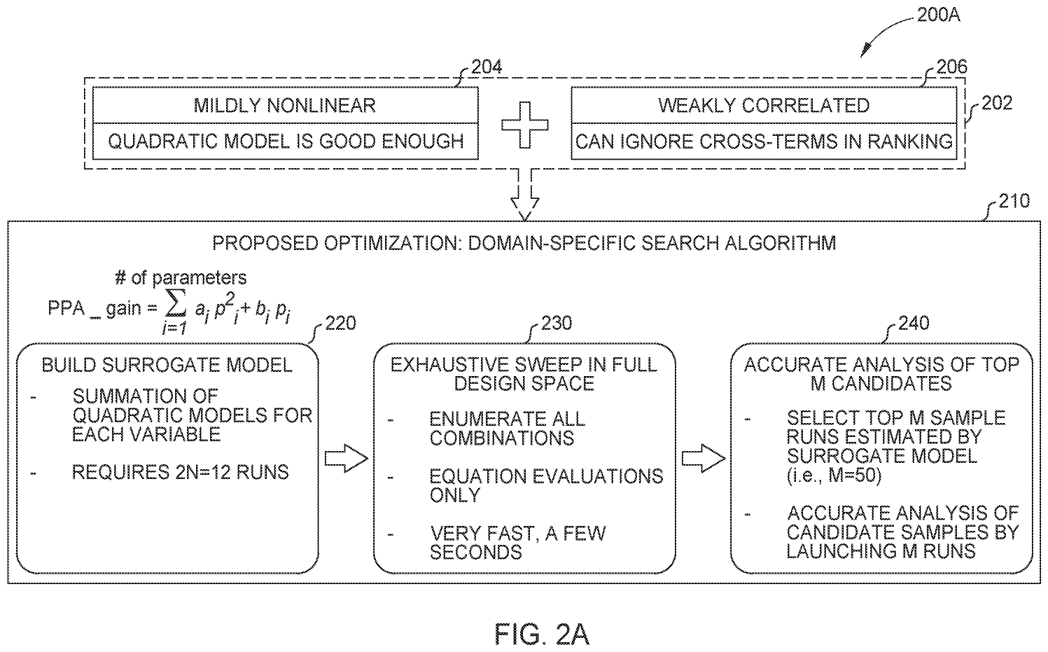

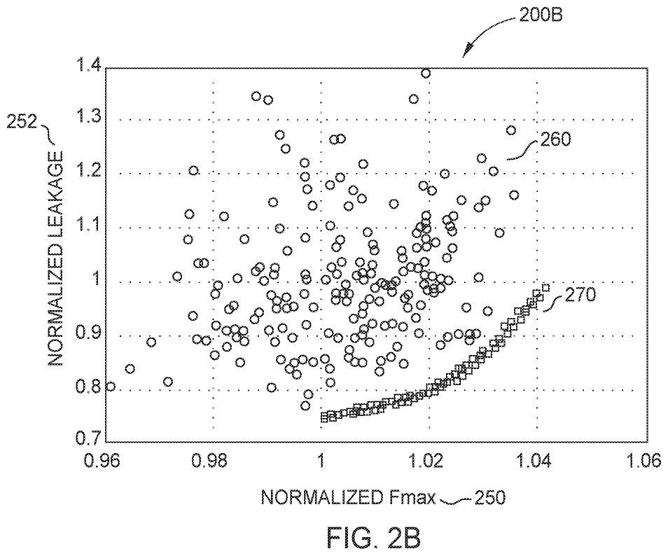

FIG. 2A illustrates an example first method for achieving fast and high-quality design-scale process optimization using a domain-specific search algorithm.

The first method 200A for fast and high-quality design-scale process optimization for different types of DTCO flows involves using a domain-driven search algorithm.

In previous methodologies, a search algorithm may be a machine learning (ML) algorithm based on an artificial intelligence (AI) search. The ML algorithm-based AI search may use generic optimization algorithms. These prior search algorithms provide different optimization quality for different applications. In other words, these prior search algorithms may be effective for some practical applications but may be ineffective for other practical applications. The domain-driven search algorithm 210 uses physical and electrical properties of process variants to drive more targeted PPA searching. The domain-driven search algorithm 210 explores the relationship between process variants and design quality, and derives an analytical PPA model, which enables fast PPA evaluation with high accuracy. The domain-driven search algorithm 210 allows for performing a full sweep and evaluating all samples or targets in the entire design optimization space to obtain a best sample set with top samples or targets. In general, the full sweep refers to a change in a measured output value over a progressing input parameter. In the instant case, the full sweep refers to searching for a PPA point within the design optimization space. A best sample set or target set provides the most desired or top or preferred or ideal or optimal samples or targets. The optimal samples or top samples (or targets) provide the highest quality PPA points or samples or targets. The top samples can also be referred to as a subset of the samples.

Before delving into the details of the domain-driven search algorithm 210, two observations are made. The first observation pertains to the non-linearity between a PPA gain and variables. The second observation pertains to a correlation between variables.

Regarding the first observation, different types of variables can have a different impact on timing and power. Some variables have a dominant impact on timing and a negligible impact on power. Alternatively, some variables have a dominant impact on power and a negligible impact on timing. An examination was conducted regarding the relationship between process variables and design quality. The examination of how several parameters impact PPA gain showed a common trend, that is, that mild non-linearity was observed between PPA gain and the variables. Mild nonlinearity may refer to a small amount of nonlinearity. Mild nonlinearity may refer to slightly noticeable or slightly detectable or slightly perceptible nonlinearity. Slightly perceptible may refer to only a few instances of detected nonlinearity by a user. For example, less than an integer number, such as 5 or 10. This observation of mild non-linearity allows the determination of a per-parameter PPA model. A quadratic fitting can be used to model the PPA impact of each parameter with reasonable accuracy.

Regarding the second observation, weak or insubstantial correlation among process parameters and cross-parameter terms can be ignored. Weak correlation can refer to insubstantial correlation or relationship between parameters. Weak correlation can refer to a weak linear relationship between two quantitative variables. Weak correlation can also refer to a statistical relationship between two variables where the values may be close together, but not directly proportional. A correlation coefficient is usually less than 0.3 for a weak correlation. The correlation coefficient can be a measure of how closely related two variables are. As such, linear superposition of impacts of each individual parameter can used to obtain a combined PPA gain. Therefore, a linear superposition of impacts of each variable provides for reasonable accuracy.

The domain-driven search algorithm 210 is based on the first and second observations. In the first method 200A, the conclusions of the two observations 202 are combined. In other words, the first conclusion 204 regarding some mild non-linearity is combined with the second conclusion 206 regarding weak variable correlation to develop the domain-driven search algorithm 210. The domain-driven search algorithm 210 performs the following steps, that is, constructs a surrogate model 220, performs an exhaustive sweep 230 in the full design or optimization space, and performs analysis 240 of the top or best M candidates.

The surrogate model 220 is constructed by building a quadratic model to represent the PPA impact of each process parameter or variable. The quadratic model is a mathematical model represented by a quadratic equation or a system of quadratic equations. A quadratic equation representing the impact from each parameter is shown. The PPA impact of each process parameter or variable is represented as a quadratic model. The quadratic models for all the process parameters or variables are summed or added together. The construction of the quadratic models uses 2N runs, where N is the number of process parameters or variables. In one example, there are 6 process parameters or variables. This results in 2×6=12 runs because each variable includes 2 coefficients. The overall PPA gain is obtained from the summation of the quadratic models corresponding to all the variables.

In general, building the surrogate model 220, also known as a surrogate or proxy model, involves creating a simplified representation of a more complex system or process. Surrogate models are used in various fields, including engineering, optimization, machine learning, and simulation, to approximate the behavior of a more intricate and computationally expensive model. The purpose of building the surrogate model 220 is to obtain a faster and less resource-intensive way to make predictions or perform analyses.

Surrogate models are usually employed when dealing with complex systems or simulations that are computationally expensive or time-consuming. These systems could include physical experiments, numerical simulations, or other processes. To build the surrogate model 220, a set of training data is used. The training data is often obtained by running the complex model or simulation at various input points. The input-output pairs from these simulations are then used to train the surrogate model 220.

The surrogate model 220 captures the essential relationships between inputs and outputs without replicating the full complexity of the original model. Once the surrogate model 220 is trained, it can be used for making predictions or conducting analyses at a much lower computational cost compared to the original model. This is particularly useful in scenarios where rapid evaluations or optimizations are required. The surrogate model 220 can be iteratively refined as more data becomes available or as the complexity of the problem is better understood. This iterative process helps improve the accuracy of the surrogate model 220 over time. Thus, building the surrogate model 220 allows practitioners to balance the trade-off between computational cost and model accuracy, making it a valuable tool in scenarios, such as maximizing PPA gains, where efficiency and speed are essential.

After building the surrogate model 220, the exhaustive sweep 230 of the entire optimization space is performed. All the combinations of variables are enumerated very quickly, e.g., in a few seconds.

After the exhaustive sweep 230 of the entire optimization space is performed, an analysis 240 is performed of the top or best or most relevant M candidates. After the top or best M candidates or sample candidates are obtained from the surrogate model 220, the analysis 240 is performed by launching M runs to determine the PPA gain. In one example, M=50. In other words, the method selects the top M sample runs (e.g., M=50) estimated by the surrogate model 220. Thus, the PPA gain of the top 50 samples or targets is obtained. Of course, M can be set to any other integer number based on desired design criteria. The top M candidates or best M candidates are the ones that exhibit the strongest statistical relationship between process parameters, that is, high linearity and strong correlation.

The domain-driven search algorithm 210 was tested on a central processing unit (CPU) block and the results were plotted, as shown in FIG. 2B.

FIG. 2B illustrates PPA points or samples on a plot 200B when using the domain-specific search algorithm.

In one example, the domain-driven search algorithm 210 was tested on a central processing unit (CPU) block with 6 FEOL process parameters or variables. In the plot 200B, the x-axis represents normalized Fₘₐₓ 250 and the y-axis represents normalized leakage 252. When a conventional AI algorithm is employed, a 3.91% PPA gain is obtained after 200 runs. The samples 260 are the result of using the conventional AI algorithm. The samples 260 are scattered across the plot. In contrast, when the domain-driven search algorithm 210 is employed, a 4.43% PPA gain is obtained after only 62 runs. The 62 runs are derived from 2N+M=(2×6)+50=12+50−62. The domain-driven search algorithm 210 thus provides for a better PPA gain with less runs. The samples 270 are the result of using the domain-driven search algorithm 210. The samples 270 are the top ranked process points or PPA points and are shown concentrated along a curved line.

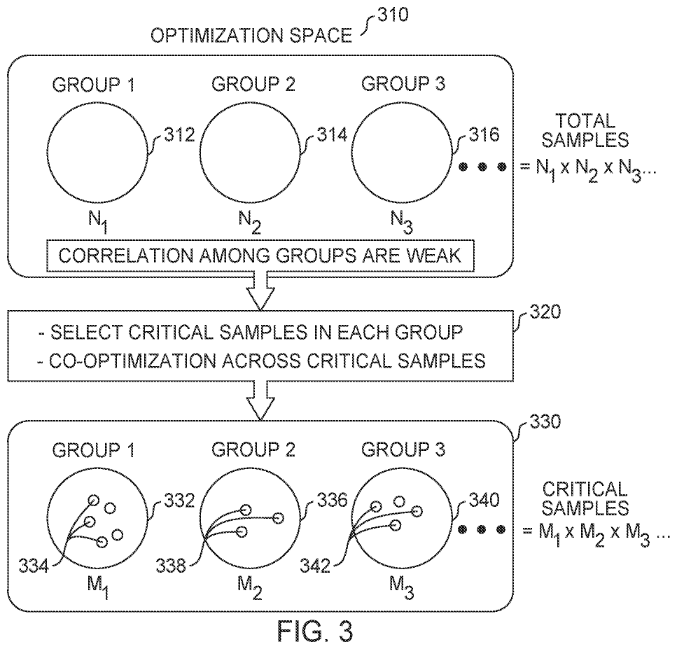

FIG. 3 illustrates an example second method for achieving fast and high-quality design-scale process optimization by performing co-optimization of multiple groups.

The second method for fast and high-quality design-scale process optimization for different types of DTCO flows involves performing fast co-optimization of multiple groups.

The optimization space 310 includes a plurality of groups. In the instant example, there is a first group 312, a second group 314, and a third group 316. The first group 312 can include N₁ samples, the second group 314 can include N₂ samples, and the third group 316 can include N₃ samples. The total number of samples is N₁×N₂×N₃. The correlation of variables among the groups is weak or insubstantial. It is noted that each group may include a very large number of samples or points. As such, the optimization space of the first group 312 is very large and the optimization space of the second group 314 is also very large. If the first group 312 is combined with the second group 314 (multiple), then the resulting co-optimization space becomes extremely large and millions to billions of samples may be generated. Executing on such large dataset results in a runtime problem during sample evaluation, as such processing is time-consuming and not cost effective.

At 320, critical samples are selected in each group and co-optimization is performed across the critical samples from all the groups. The critical samples are considered the top candidates.

The optimization space 330 has been adjusted to provide for co-optimization. The first group 332 depicts the critical samples 334, the second group 336 depicts the critical samples 338, and the third group 340 depicts the critical samples 342. The total number of critical samples is M₁×M₂× M₃. As such, only the critical samples or top candidates from each group are used to generate the co-optimization space. This significantly reduces the runtime because instead of processing millions to billions of samples, only a few hundred or a few thousand samples (critical samples or top candidate samples) are processed. The critical samples can also be referred to as important samples, meaningful samples, consequential samples, purposeful samples or useful samples or relevant samples. Samples are considered critical or consequential or meaningful or purposeful if such samples have a significant or substantial or serious or important impact on PPA gains. The critical samples can also be referred to as target samples or candidate samples or dominant samples.

In one practical example, co-optimization can occur for FEOL and BEOL processes. The fabrication process of very large scale integration (VLSI) IC consists of a set of basic steps starting from crystal growth, wafer preparation, epitaxy, dielectric and poly Si film deposition, oxidation, lithography, and dry etching. Different patterns are developed using photoresist and masks, and after forming the pattern, the photoresist is stripped out of the wafer. During the fabrication process, the devices are created on the chip and many of these basic steps are repeated multiple times. Depending on dose or energy of ion implantation, process threshold voltages can change. Moreover, the position of the chip in the wafer determines the threshold voltage and mobility. As such, all the chips fabricated on the same wafer may differ in performance. The fabrication process is divided into FEOL, middle-of-line (MOL), and BEOL. The FEOL pertains to transistor level layout design, the MOL pertains to transistor level interconnects, and the BEOL pertains to percentage of netlist recovery (PnR) level interconnects.

The FEOL covers the processing of the active parts of the chips, i.e., the transistors that reside on the bottom of the chip. The transistor serves as an electrical switch and uses three electrodes for its operation, that is, a gate, a source, and a drain. Electrical current in the conduction channel between source and drain can be switched ON and OFF, an operation that is controlled by the gate voltage.

The BEOL, the final stage of processing, refers to the interconnects that reside in the top part of the chip. Interconnects are complex wiring schemes that distribute clock and other signals, provide power and ground, and transfer electrical signals from one transistor to another. The BEOL is organized in different metal layers, local (Mx), intermediate, semi-global and global wires. The total number of layers can be as many as 15, while the typical number of Mx layers ranges between 3 and 6. Each of these layers contains (unidirectional) metal lines, organized in regular tracks, and dielectric materials. They are interconnected vertically by means of via structures that are filled with metal.

The FEOL and the BEOL are tied together by the MOL. As device scaling continues to 3 nm and below, the processing of each of these modules comes with many challenges. This forces chip makers to move to new device architectures in the FEOL and to new materials and integration schemes in the BEOL. FEOL process changes have a dominant impact on chip performance and leakage power and BEOL process changes can more effectively impact chip performance and dynamic power. Therefore, co-optimization of the FEOL and BEOL can result in significant maximization of PPA gains.

However, as noted above, different types of transistors and interconnect layers have different process variants, even for the same type of transistor or interconnect layer. The process parameters may be different from one die to another die due to differences in mask, lithography, chemical mechanical polishing (CMP), etc. The combinations of two types of process changes can result in a very large number of samples leading to a prohibitively high runtime.

In the example above with regards to FIG. 2B, if 6 process parameters or variables are assumed for the FEOL process, and each parameter varies within a range of [−30 mV, 30 mV] with a resolution of 5 mV, the resultant search space will have about 4.8 million samples. For the BEOL process, if the same design has 12 metal layers, and each layer has a thickness varying in a range of [−20%, +20%] with a resolution of 10%, the resultant search space will have about 244 million samples. Therefore, the number of samples in the co-optimization space (both FEOL and BEOL) would be about 4.8 million×244 million=1.17×10¹⁵ samples. Processing such a large number of samples will create a runtime problem during sample evaluation.

The second method proposes combining the FEOL and BEOL process optimizations in an efficient and effective manner. As shown in FIG. 3, there are multiple groups for co-optimization and each group represents one type of optimization space. In each optimization space, not all the samples are critical or important or beneficial for PPA gain. The second method involves selecting critical samples from each group using the domain-driven search algorithm 210 and performing co-optimization only among the critical samples of the groups. When the correlation between the variables in the groups is not strong or weak or insubstantial, the second method can significantly reduce the number of sample evaluations, while preserving a high optimization quality.

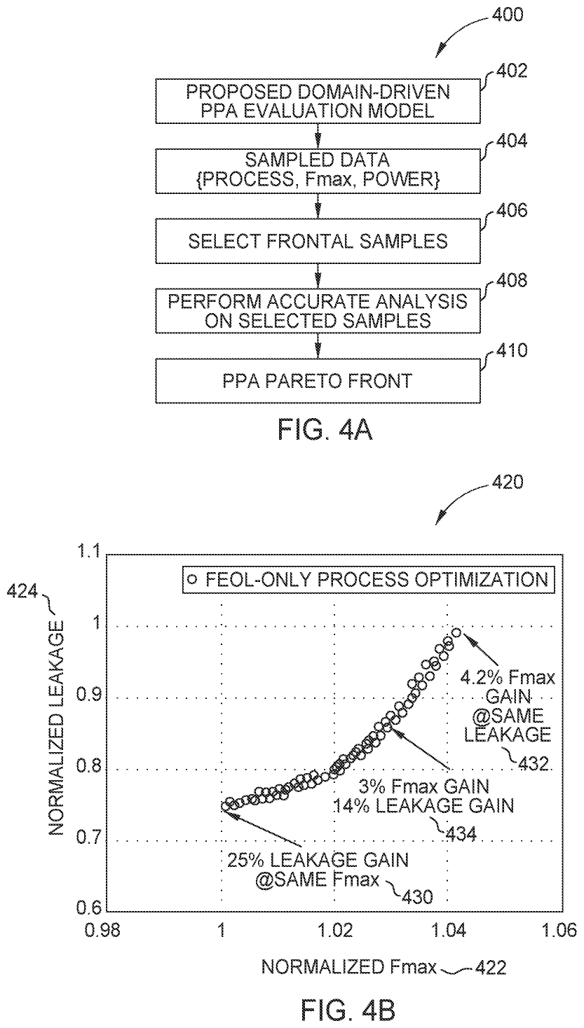

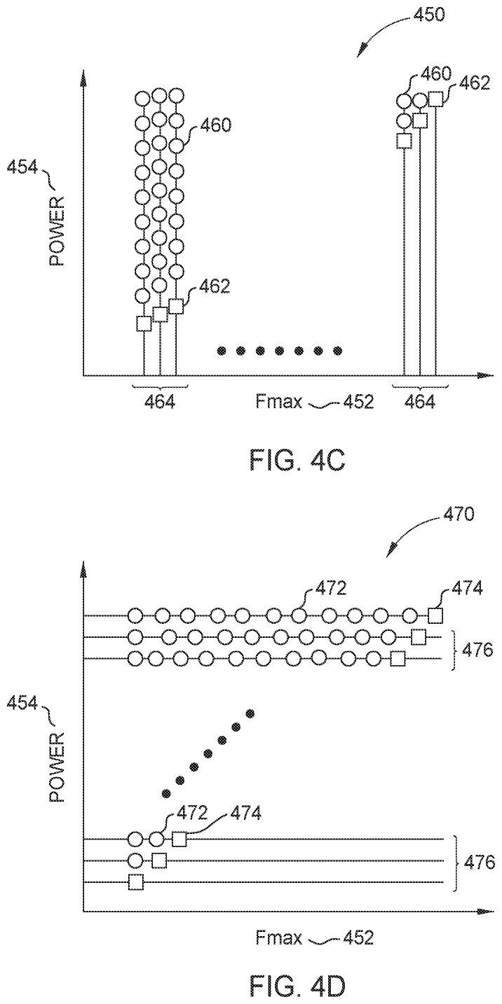

FIG. 4A illustrates an example flowchart 400 of a third method for achieving fast and high-quality design-scale process optimization using a PPA Pareto front.

At 402, the domain-driven search algorithm 210 performs PPA evaluation to evaluate all the samples in the entire optimization space. As such, the PPA evaluation model is obtained using the domain-driven search algorithm 210.

At 404, the sampled data is obtained. The sampled data can be, e.g., process data, Fₘₐₓ data, power data, etc. Thus, the derived PPA model to assess Fₘₐₓ and power is used for each process point or each sample.

At 406, frontal samples are selected. The updated PPA frontal sample set based on Fₘₐₓ and power data is obtained.

At 408, the selected samples are analyzed. The analysis is performed on the frontal samples by launching full design runs to generate a precise PPA Pareto front. The analysis includes analyzing top M candidates. In one example, the top M candidates are 50 candidates. The top M candidates are selected or chosen by the surrogate model. The analysis involves determining nonlinearity and correlation between process parameters. In particular, the analysis involves determining whether the nonlinearity is mild or not and determining whether the correlation is weak or not. Thus, the analysis involves determining various relationships between process parameters, such as statistical relationships between process parameters. The determination involves discovering, e.g., how strong the statistical relationship is between process parameters. The determination of the strength or weakness relationships between process parameters enables the user to find the optimal PPA points.

At 410, the PPA Pareto front is generated.

The third method generates the PPA Pareto front. The PPA Pareto front is the best process set covering the entire performance and power range. The PPA Pareto front can determine what the best Fₘₐₓ/Power is, and determine a tradeoff between Fₘₐₓ and power. The PPA Pareto front determining the tradeoff between Fₘₐₓ and power is shown in FIG. 4B.

FIG. 4B illustrates the PPA points or samples on a plot 420 when using the PPA Pareto front.

In the plot 420, the x-axis represents normalized Fₘₐₓ 422 and the y-axis represents normalized leakage 424. The curved line depicts the concentration of the samples. The best power solution set is located at point 430, where 25% leakage power is obtained. The best performance solution set is located at point 432, where 4.2% Fₘₐₓ gain is obtained. The combined best power and performance solution can be found at point 434, where 3% Fₘₐₓ gain and 14% leakage gain are obtained.

FIG. 4C illustrates an example plot 450 of a collection of best samples in all bins according to a first embodiment.

Given a metric, e.g., Fₘₐₓ gain, a metric resolution is selected. The entire metric range is divided into multiple bins. The bin size is the specified resolution. Once a new process point (e.g., process, Fₘₐₓ, power) is evaluated, its corresponding Fₘₐₓ bin is found, and the best process point that has the largest power gain inside this bin is updated. After all the process points are evaluated, the best process point from each of the bins is collected and used as a frontal sample.

Referring to FIG. 4C, the plot 450 includes an x-axis representing Fₘₐₓ 452 and a y-axis representing power 454. The bins are designated as 464. Each bin 464 includes samples 460. The samples 460 can also be referred to as data points. The best sample 462 from each bin 464 is ultimately selected. The bins 464 are represented as vertical lines to evaluate Fₘₐₓ.

The Fₘₐₓ has a specified range. The Fₘₐₓ can be divided along this range into a plurality of bins, e.g., the bins 464. In one example, there could be 100 bins and the resolution of Fₘₐₓ can be, e.g., 0.05%. The samples 460 are distributed within each of the bins 464. Each bin 464 can include a different number of samples 460. As such, a number of samples in each bin 464 can have a same frequency. However, the samples 460 in each bin 464 have a different power value. The goal is to determine a best power value in each bin 464 for the samples 460 in such bin. The best sample in each bin 464 is designated as 462. The best sample 462 can be continuously updated as samples 460 are added to the bins 464. Therefore, the best sample 462 provides the best power value for such frequency. Stated differently, the best sample 462 in each bin 464 represents a best combination of power value and frequency value, and this is how the frontal samples are generated. The best samples 462 can be referred to as Pareto frontal samples that are utilized by a user.

FIG. 4D illustrates an example plot 470 of a collection of best samples in all bins according to a second embodiment.

The plot 470 includes an x-axis representing Fₘₐₓ 452 and a y-axis representing power 454. The bins are designated as 476. Each bin 476 includes samples 472. The samples 472 can also be referred to as data points. The best sample 474 from each bin 476 is ultimately selected. The bins 476 are represented as horizontal lines to evaluate power.

The power has a specified range. The power can be divided along this range into a plurality of bins, e.g., the bins 476. In one example, there could be 100 bins and the resolution of the power can be, e.g., 0.05%. The samples 472 are distributed within each of the bins 476. Each bin 476 can include a different number of samples 472. As such, a number of samples in each bin 476 can have a same power. However, the samples 472 in each bin 476 have a different frequency value. The goal is to determine a best frequency value in each bin 476 for the samples 472 in such bin. The best sample in each bin 476 is designated as 474. The best sample 474 can be continuously updated as samples 472 are added to the bins 476. Therefore, the best sample 474 provides the best frequency value for such power level. Stated differently, the best sample 474 in each bin 476 represents a best combination of power value and frequency value, and this is how the frontal samples are generated. The best samples 474 can be referred to as Pareto frontal samples that are utilized by a user.

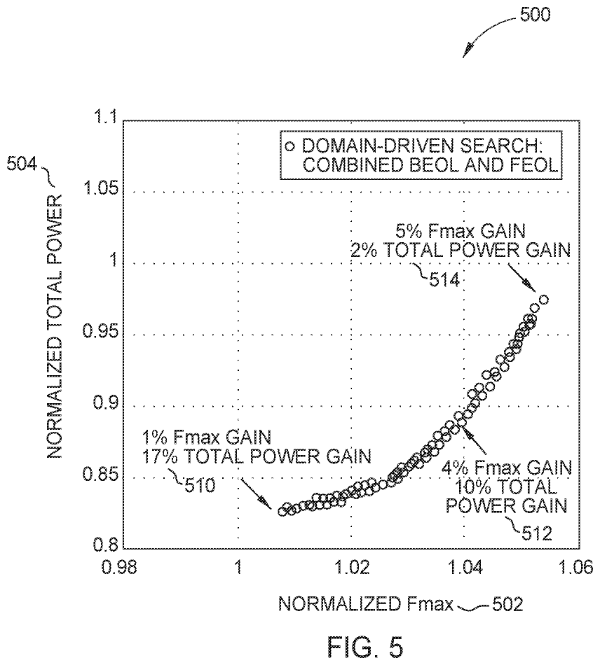

FIG. 5 illustrates an example plot 500 where designers can select PPA points based on design requirements.

The plot 500 includes an x-axis representing Fₘₐₓ 502 and a y-axis representing power 504. The curved line depicts the concentration of the samples. The best power solution set is located at point 410, where 17% total power gain is obtained, with 1% Fₘₐₓ gain. The best performance solution set is located at point 514, where 5% Fₘₐₓ gain is obtained, with a 2% power gain. The combined best power and performance solution can be found at point 512 where 4% Fₘₐₓ gain is obtained and 10% power gain is obtained. This plot 500 can pertain to the second method. In particular, this may be a 4 nm production of a CPU core including 6 FEOL process parameters or variables and 12 BEOL process parameters or variables. Thus, when co-optimization is performed for both the FEOL and BEOL, a designer can choose between points 510, 512, 514 to meet desired system performance criteria. Of course, a designer can choose any points along the curved line for meeting desired system performance criteria. The design runs have been reduced from 10¹⁵ runs to a few hundred runs. Additionally, the turnaround time (TAT) is less than 30 hours.

In conclusion, methods are presented for fast and high-quality design-scale process optimization for different types of DTCO flows. The first method for fast and high-quality design-scale process optimization for different types of DTCO flows involves using a domain-driven search algorithm employing a surrogate model. The second method for fast and high-quality design-scale process optimization for different types of DTCO flows involves performing fast co-optimization of multiple groups. In one practical application, the multiple groups include combining FEOL and BEOL processes. The third method for fast and high-quality design-scale process optimization for different types of DTCO flows involves performing fast generation of the PPA Pareto front. The PPA Pareto front allows for a designer to select an optimal PPA point. Optimal solution sets can be generated for best Fₘₐₓ, best power, and/or a tradeoff between Fₘₐₓ and power. The three methods enable fast DTCO and can be applied to different types of DTCO flows such as early DTCO, late DTCO, and STA driven or implementation tool driven DTCO for process selection.

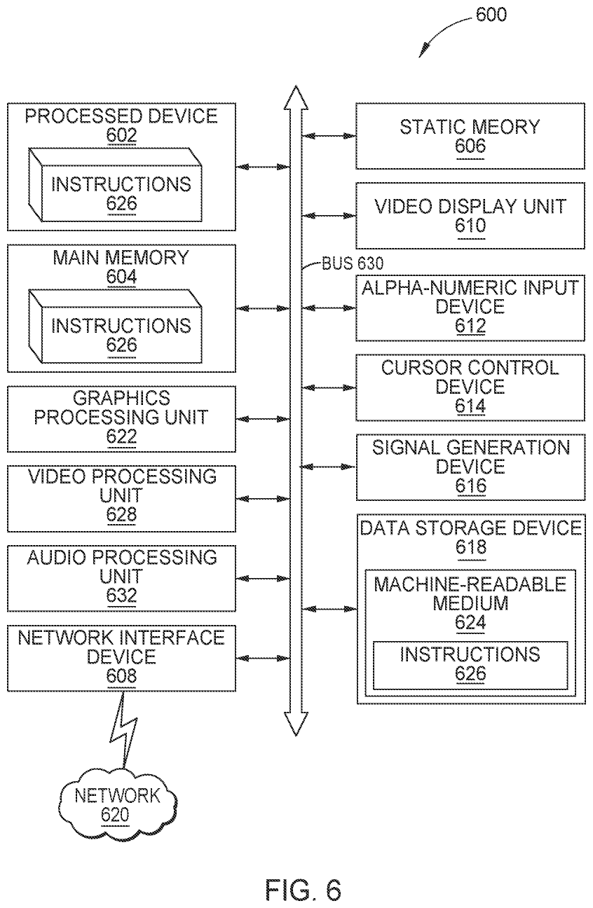

FIG. 6 illustrates an example computer system in which embodiments of the present disclosure may operate.

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a local area network (LAN), an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable medium) on which is stored one or more sets of instructions 626 or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 602 to perform any one or more of the methodologies of the present disclosure. The term “machine-readable storage medium” shall accordingly be taken to include, but not be limited to, solid-state memories, optical media, and magnetic media.

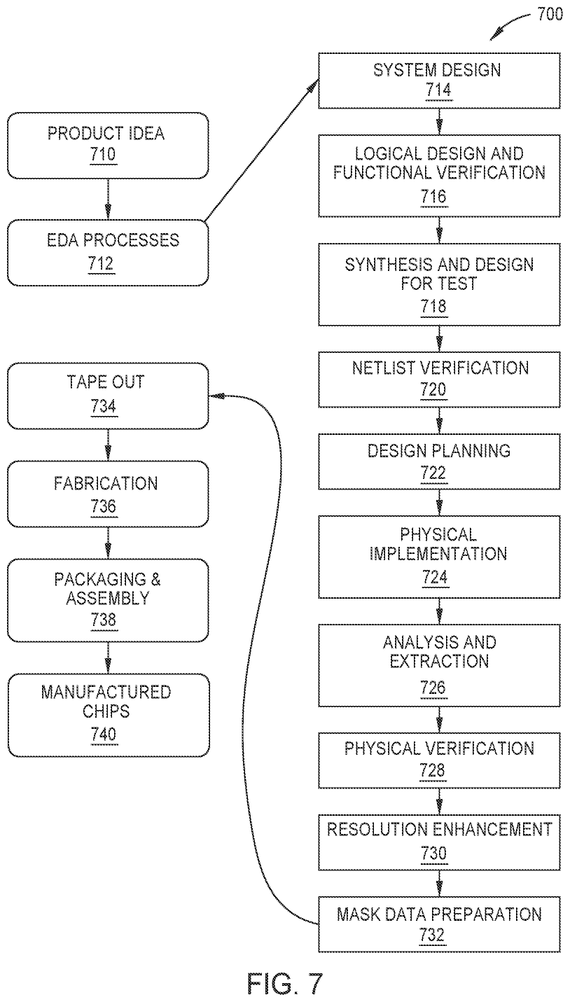

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding tools of that layer (e.g., a formal verification tool). The processes described by be enabled by EDA products (or tools).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flip-flop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

A storage subsystem of a computer system (such as computer system 700 of FIG. 10) may be used to store the programs and data structures that are used by some or all of the EDA products described herein, and products used for development of cells for the library and for physical and logical design that use the library.

The present disclosure relates to methods for fast and high-quality design-scale process optimization for different types of DTCO flows. The first method for fast and high-quality design-scale process optimization for different types of DTCO flows involves using a domain-driven search algorithm employing a surrogate model. The second method for fast and high-quality design-scale process optimization for different types of DTCO flows involves performing fast co-optimization of multiple groups. In one practical application, the multiple groups include combining FEOL and BEOL processes. The third method for fast and high-quality design-scale process optimization for different types of DTCO flows involves performing fast generation of the PPA Pareto front. The PPA Pareto front allows for a designer to select an optimal PPA point. Optimal solution sets can be generated for best Fₘₐₓ, best power, and/or a tradeoff between Fₘₐₓ and power. The three methods enable fast DTCO and can be applied to different types of DTCO flows such as early DTCO, late DTCO, and STA driven or implementation tool driven DTCO for process selection.

In one example, a method includes constructing a surrogate model representing an impact of a plurality of metrics to a plurality of process parameters, performing a sweep to determine a number of samples in an optimization space including the plurality of process parameters, selecting a subset of sample candidates from the surrogate model, and generating, by a processing device, a PPA model based on the subset of sample candidates to output improved sample sets. The subset of sample candidates are the top M candidates or best M candidates or optimal M candidates that exhibit the strongest statistical relationship between process parameters, that is, high linearity and strong correlation.

In another example, a method includes creating multiple groups in an optimization space, each group including samples of a different process parameter, selecting dominant samples in each group, and performing co-optimization using the dominant samples from each group.

In yet another example, a method includes generating a power, performance and area (PPA) model using a domain-driven search algorithm, assessing, using the PPA model, a first metric and a second metric for each of a plurality of process parameters, updating a PPA frontal sample set including a plurality of samples based on first metric data and second metric data, and performing analysis on the PPA frontal sample set to generate a PPA Pareto front.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementation of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
constructing a surrogate model representing an impact of a plurality of metrics to a plurality of process parameters;
performing a sweep to determine a number of samples in an optimization space including the plurality of process parameters;
selecting a subset of sample candidates from the surrogate model; and
generating, by a processing device, a PPA model based on the subset of sample candidates to output improved sample sets.

2. The method of claim 1, wherein the surrogate model is a summation of multiple quadratic models for each process parameter.

3. The method of claim 2, wherein a mild nonlinearity between PPA gains and the plurality of process parameters enables using the quadratic models.

4. The method of claim 2, wherein weak correlation between the plurality of process parameters enables using the quadratic models.

5. The method of claim 1, wherein the sweep involves enumerating all combinations of the plurality of process parameters.

6. The method of claim 1, wherein each process parameter involves two runtimes.

7. The method of claim 1, wherein the subset of sample candidates are displayed in a condensed manner along a curved line.

8. The method of claim 1, wherein the subset of sample candidates exhibit strong statistical correlation between subsets of process parameters of the plurality of process parameters.

9. The method of claim 1, wherein the surrogate model is executed by a domain-driven search algorithm and wherein the domain-driven search algorithm is used on different types of design technology co-optimization (DTCO) flows.

10. A method comprising:
creating multiple groups in an optimization space, each group including samples of a different process parameter;
selecting dominant samples in each group; and
performing co-optimization using the dominant samples from each group.

11. The method of claim 10, wherein a first group of the multiple groups includes samples related to front-end-of-line (FEOL) process changes and a second group of the multiple groups includes samples related to back-end-of-line (BEOL) process changes.

12. The method of claim 10, wherein the dominant samples are displayed in a condensed manner along a curved line.

13. The method of claim 10, wherein the dominant samples include a few hundred samples.

14. The method of claim 10, wherein the dominant samples in each group are selected using a domain-driven search algorithm.

15. A method comprising:
generating a power, performance and area (PPA) model using a domain-driven search algorithm;
assessing, using the PPA model, a first metric and a second metric for each of a plurality of process parameters;
updating a PPA frontal sample set including a plurality of samples based on first metric data and second metric data; and
performing analysis on the PPA frontal sample set to generate a PPA Pareto front.

16. The method of claim 15, wherein the first metric is frequency and the second metric is power.

17. The method of claim 16, further comprising selecting a resolution for the first metric.

18. The method of claim 17, wherein the analysis of the PPA frontal sample set includes:
dividing a range of the first metric into multiple bins, each bin size of the multiple bins of the first metric determined by the resolution of the first metric;
assigning the plurality of samples into the multiple bins associated with the first metric; and
updating an optimal sample set in each bin associated with the first metric.

19. The method of claim 18, further comprising collecting each optimal sample set from each bin to create a group of optimal frontal samples.

20. The method of claim 16, further comprising selecting a resolution for the second metric such that the analysis of the PPA frontal sample set includes:
dividing a range of the second metric into multiple bins, each bin size of the multiple bins of the second metric determined by the resolution of the second metric;
assigning the plurality of samples into the multiple bins associated with the second metric;
updating an optimal sample set in each bin associated with the second metric; and
collecting each optimal sample set from each bin to create a group of optimal frontal samples.
